(19) United States
(12) Patent Application Publication
(10) Pub. No.: US 2003/0051030 A1
(43) Pub. Date: Mar. 13, 2003

(54) Distributed metric discovery and collection in a distributed system

(76) Inventors: James B. Clarke, Sanford, FL (US); Richard Manning, Sewanee, GA (US); Dennis G. Reedy, Manassas, VA (US)

Correspondence Address: FINNEGAN, HENDERSON, FARABOW,, GARRETT & DUNNER, L.L.P., 1300 I STREET, N.W., WASHINGTON, DC, 20005-3315, US

(21) Appl. No.: 09/947,549

(22) Filed: Sep. 7, 2001

(51) Int. Cl. G06F 15/173

(52) U.S. Cl. 709/224

(57) ABSTRACT

Systems and methods collect metrics and make them available on a distributed system. Any type of metrics, such as quantities, elapsed time, and temperature, may be collected. The collected metrics are stored in distributed repositories running anywhere on the network. These repositories can be made available over the distributed system using the Jini™ lookup service or other lookup services.

### RELATED APPLICATIONS

This application is related to an application for Dynamic Provisioning of Service Components in a Distributed System, attorney docket no. 06502.0382, filed on Sep. 7, 2001, which is relied upon and incorporated by reference.

### FIELD OF THE INVENTION

This invention relates to collecting metrics in a distributed system and, more particularly, to methods and systems for collecting metrics and making them available on a distributed system.

### BACKGROUND OF THE INVENTION

Distributed systems today enable a device connected to a communications network to take advantage of services available on other devices located throughout the network. Each device in a distributed system may have its own internal data types, its own address alignment rules, and its own operating system. To enable such heterogeneous devices to communicate and interact successfully, developers of distributed systems can employ a remote procedure call (RPC) communication mechanism.

RPC mechanisms provide communication between processes (e.g., programs, applets, etc.) running on the same device or different devices. In a simple case, one process, i.e., a client, sends a message to another process, i.e., a server. The server processes the message and, in some cases, returns a response to the client. In many systems, the client and server do not have to be synchronized. That is, the client may transmit the message and then begin a new activity, or the server may buffer the incoming message until the server is ready to process the message.

The Java™ programming language is an object-oriented programming language that may be used to implement such a distributed system. The Java™ language is compiled into a platform-independent format, using a bytecode instruction set, which can be executed on any platform supporting the Java™ virtual machine (JVM). The JVM may be implemented on any type of platform, greatly increasing the ease with which heterogeneous machines can be federated into a distributed system.

Conventional systems provide for the collection of metrics in a client-server environment. Typically, when a measurement process is initiated on a client machine, the process must be told where the server is, i.e., where the metrics are stored. This limits the flexibility of metric collection in a distributed system. It is therefore desirable to provide tools to collect metrics and make them available on a distributed system.

### SUMMARY OF THE INVENTION

Methods and systems consistent with the present invention provide these tools and enable the collection of any type of metrics, such as quantities, elapsed time, and temperature, etc. In accordance with an aspect of the invention, a system is provided to store collected metrics in distributed repositories running anywhere on a network.

Consistent with an aspect of the present invention, a system for collecting metrics in a distributed system includes a data source configured to store metrics running on a node in the distributed system. The system also includes a measuring agent configured to measure a metric related to a process in the distributed system and write the metric to the data source. The system also includes a lookup service configured to receive a registration for the data source and use the registration to make the data source available to other nodes in the distributed system.

Consistent with another aspect of the present invention, a method collects metrics in a distributed system by measuring a metric about a process running on a node in the distributed system and storing the metric in a data source available to other nodes in the distributed system, wherein the data source runs on the same node as the process.

Consistent with another aspect of the present invention, a method collects metrics in a distributed system by measuring a metric about a process running on a node in the distributed system, locating a data source running on a different node from the process, and storing the metric in the data source, wherein the data source is available to other nodes in the distributed system.

Additional features of the invention will be set forth in part in the description which follows, and in part will be obvious from the description, or may be learned by practice of the invention.

### BRIEF DESCRIPTION OF THE DRAWINGS

It is to be understood that both the foregoing general description and the following detailed description are exemplary and explanatory only and are not restrictive of the invention, as claimed. The accompanying drawings, which are incorporated in and constitute a part of this specification, illustrate several embodiments of the invention and together with the description, serve to explain the principles of the invention. In the drawings:

FIG. 1 is a high level block diagram of an exemplary system for practicing systems and methods consistent with the present invention;

FIG. 2 depicts a computer in greater detail to show a number of the software components of an exemplary distributed system consistent with the present invention;

FIG. 3 depicts an embodiment of the discovery process in more detail, in accordance with the present invention;

FIG. 4 is a flow chart of an embodiment of the event handling process, in accordance with the present invention;

FIG. 5 is a block diagram of an exemplary operational string, in accordance with the present invention;

FIG. 6 is a block diagram of an exemplary service element, in accordance with the present invention;

FIG. 7 depicts a block diagram of a system in which a Jini Service Bean (JSB) provides its service to a client, in accordance with the present invention;

FIG. 8 depicts a block diagram of a cybernode in accordance with the present invention;

FIG. 9 depicts a block diagram of a system in which a cybernode interacts with a service provisioner, in accordance with the present invention;

FIG. 10 is a flow chart of Jini Service Bean (JSB) creation performed by a cybernode, in accordance with the present invention;

FIG. 11 is a block diagram of a service provisioner in greater detail, in accordance with the present invention;

FIG. 12 is a flow chart of dynamic provisioning performed by a service provisioner, in accordance with the present invention;

FIG. 13 is a flow chart of a process for collecting metrics, in accordance with the present invention;

FIG. 14 is a block diagram of a system for collecting metrics and storing them locally, in accordance with the present invention; and

FIG. 15 is a block diagram of a system for collecting metrics and storing them remotely, in accordance with the present invention.

### DETAILED DESCRIPTION

The following description of embodiments of this invention refers to the accompanying drawings. Where appropriate, the same reference numbers in different drawings refer to the same or similar elements.

A. Introduction

Systems consistent with the present invention simplify the provision of complex services over a distributed network by breaking a complex service into a collection of simpler services. For example, automobiles today incorporate complex computer systems to provide in-vehicle navigation, entertainment, and diagnostics. These systems are usually federated into a distributed system that may include wireless connections to a satellite, the Internet, etc. Any one of an automobile's systems can be viewed as a complex service that can in turn be viewed as a collection of simpler services.

A car's overall diagnostic system, for example, may be broken down into diagnostic monitoring of fluids, such as oil pressure and brake fluid, and diagnostic monitoring of the electrical system, such as lights and fuses. The diagnostic monitoring of fluids could then be further divided into a process that monitors oil pressure, another process that monitors brake fluid, etc. Furthermore, additional diagnostic areas, such as drive train or engine, may be added over the life of the car.

Systems consistent with the present invention provide the tools to deconstruct a complex service into service elements, provision service elements that are needed to make up the complex service, and monitor the service elements to ensure that the complex service is supported. One embodiment of the present invention can be implemented using the Rio architecture created by Sun Microsystems and described in greater detail below. Rio uses tools provided by the Jini™ architecture, such as discovery and event handling, to provision and monitor complex services in a distributed system.

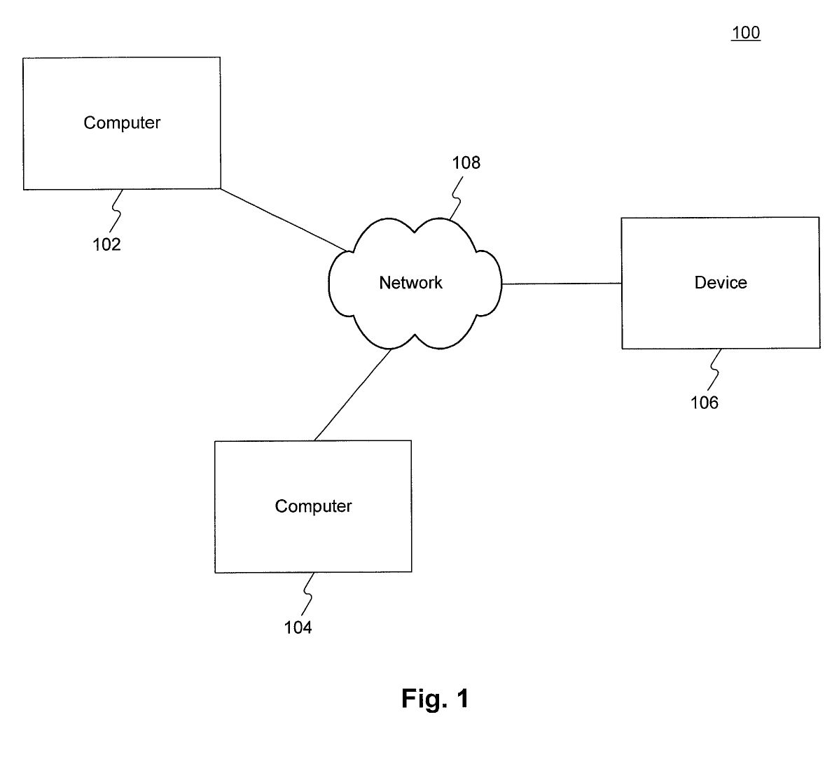

FIG. 1 is a high level block diagram of an exemplary distributed system consistent with the present invention. FIG. 1 depicts a distributed system 100 that includes computers 102 and 104 and a device 106 communicating via a network 108. Computers 102 and 104 can use any type of computing platform. Device 106 may be any of a number of devices, such as a printer, fax machine, storage device, or computer. Network 108 may be, for example, a local area network, wide area network, or the Internet. Although only two computers and one device are depicted in distributed system 100, one skilled in the art will appreciate that distributed system 100 may include additional computers and/or devices.

The computers and devices of distributed system 100 provide services to one another. A “service” is a resource, data, or functionality that can be accessed by a user, program, device, or another service. Typical services include devices, such as printers, displays, and disks; software, such as programs or utilities; and information managers, such as databases and file systems. These services may appear programmatically as objects of the Java™ programming environment and may include other objects, software components written in different programming languages, or hardware devices. As such, a service typically has an interface defining the operations that can be requested of that service.

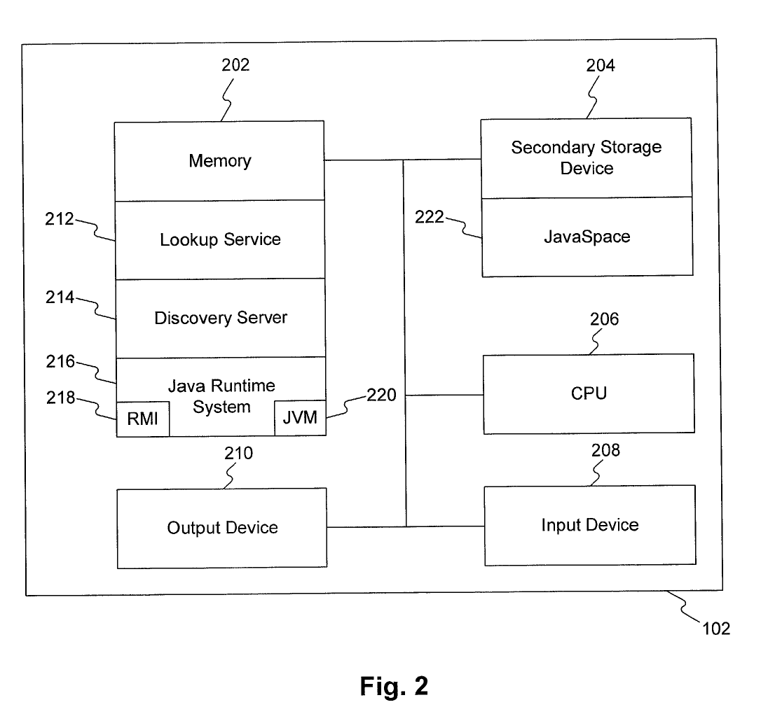

FIG. 2 depicts computer 102 in greater detail to show a number of the software components of distributed system 100. One skilled in the art will recognize that computer 104 and device 106 could be similarly configured. Computer 102 contains a memory 202, a secondary storage device 204, a central processing unit (CPU) 206, an input device 208, and output device 210. Memory 202 includes a lookup service 212, a discovery server 214, and a Java™ runtime system 216. Java™ runtime system 216 includes Remote Method Invocation (RMI) process 218 and Java™ virtual machine (JVM) 220. Secondary storage device 204 includes a Java™ space 222.

Memory 202 can be, for example, a random access memory. Secondary storage device 204 can be, for example, a CD-ROM. CPU 206 can support any platform compatible with JVM 220. Input device 208 can be, for example, a keyboard or mouse. Output device 210 can be, for example, a printer.

JVM 220 acts like an abstract computing machine, receiving instructions from programs in the form of bytecodes and interpreting these bytecodes by dynamically converting them into a form for execution, such as object code, and executing them. RMI 218 facilitates remote method invocation by allowing objects executing on one computer or device to invoke methods of an object on another computer or device. Lookup Service 212 and Discovery Server 214 are described in great detail below. Java™ space 222 is an object repository used by programs within distributed system 100 to store objects. Programs use Java space 222 to store objects persistently as well as to make them accessible to other devices within distributed system 100.

A. The Jini™ Environment

The Jini™ environment enables users to build and maintain a network of services running on computers and devices. Jini™ is an architectural framework provided by Sun Microsystems that provides an infrastructure for creating a flexible distributed system. In particular, the Jini™ architecture enables users to build and maintain a network of services on computers and/or devices. The Jini™ architecture includes Lookup Service 212 and Discovery Server 214 that enable services on the network to find other services and establish communications directly with those services.

Lookup Service 212 defines the services that are available in distributed system 100. Lookup Service 212 contains one object for each service within the system, and each object contains various methods that facilitate access to the corresponding service. Discovery Server 214 detects when a new device is added to distributed system 100 during a process known as boot and join, or discovery. When a new device is detected, Discovery Server 214 passes a reference to the new device to Lookup Service 212. The new device may then register its services with Lookup Service 212, making the device's services available to others in distributed system 100. One skilled in the art will appreciate that exemplary distributed system 100 may contain many Lookup Services and Discovery Servers.

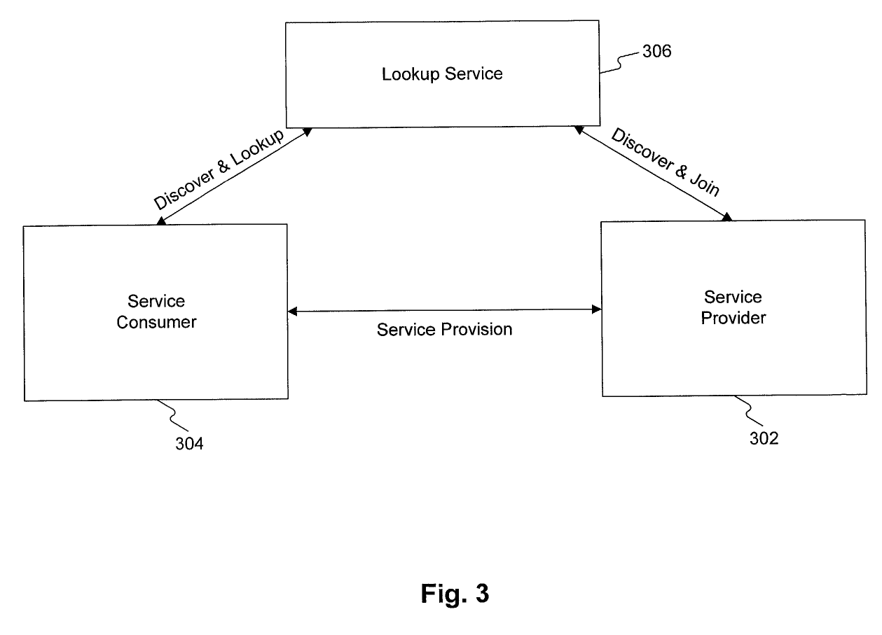

FIG. 3 depicts an embodiment of the discovery process in more detail. This process involves a service provider 302, a service consumer 304, and a lookup service 306. One skilled in the art will recognize that service provider 302, service consumer 304, and lookup service 306 may be objects running on computer 102, computer 104, or device 106.

As described above, service provider 302 discovers and joins lookup service 306, making the services provided by service provider 302 available to other computers and devices in the distributed system. When service consumer 304 requires a service, it discovers lookup service 306 and sends a lookup request specifying the needed service to lookup service 306. In response, lookup service 306 returns a proxy that corresponds to service provider 302 to service consumer 304. The proxy enables service consumer 304 to establish contact directly with service provider 302. Service provider 302 is then able to provide the service to service consumer 304 as needed. An implementation of the lookup service is explained in “The Jini™ Lookup Service Specification,” contained in Arnold et al., The Jini™ Specification, Addison-Wesley, 1999, pp. 217-231.

Distributed systems that use the Jini™ architecture often communicate via an event handling process that allows an object running on one Java™ virtual machine (i.e., an event consumer or event listener) to register interest in an event that occurs in an object running on another Java™ virtual machine (i.e., an event generator or event producer). An event can be, for example, a change in the state of the event producer. When the event occurs, the event consumer is notified. This notification can be provided by, for example, the event producer.

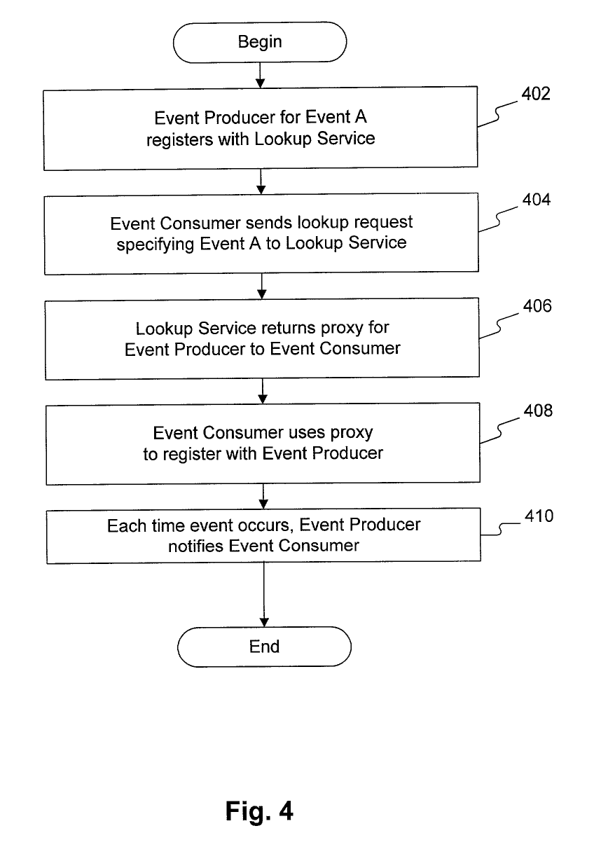

FIG. 4 is a flow chart of one embodiment of the event handling process. An event producer that produces event A registers with a lookup service (step 402). When an event consumer sends a lookup request specifying event A to the lookup service (step 404), the lookup service returns a proxy for the event producer for event A to the event consumer (step 406). The event consumer uses the proxy to register with the event producer (step 408). Each time the event occurs thereafter, the event producer notifies the event consumer (step 410). An implementation of Jini™ event handling is explained in “The Jini™ Distributed Event Specification,” contained in Arnold et al., The Jini™ Specification, Addison-Wesley, 1999, pp. 155-182.

B. Overview of Rio Architecture

The Rio architecture enhances the basic Jini™ architecture to provision and monitor complex services by considering a complex service as a collection of service elements. To provide the complex service, the Rio architecture instantiates and monitors a service instance corresponding to each service element. A service element might correspond to, for example, an application service or an infrastructure service. In general, an application service is developed to solve a specific application problem, such as word processing or spreadsheet management. An infrastructure service, such as the Jini™ lookup service, provides the building blocks on which application services can be used. One implementation of the Jini lookup service is described in U.S. Pat. No. 6,185,611, for “Dynamic Lookup Service in a Distributed System.”

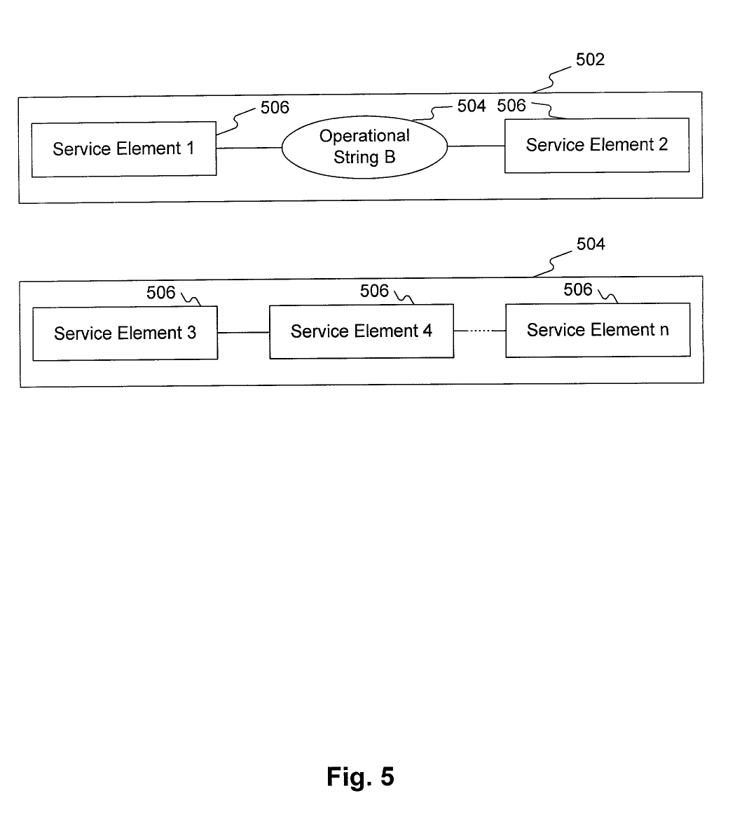

Consistent with the present invention, a complex service can be represented by an operational string. FIG. 5 depicts a exemplary operational string 502 that includes one or more service elements 506 and another operational string 504. Operational string 504 in turn includes additional service elements 506. For example, operational string 502 might represent the diagnostic monitoring of an automobile. Service element 1 might be diagnostic monitoring of the car's electrical system and service element 2 might be diagnostic monitoring of the car's fluids. Operational string B might be a process to coordinate alerts when one of the monitored systems has a problem. Service element 3 might then be a user interface available to the driver, service element 4 might be a database storing thresholds at which alerts are issued, etc. In an embodiment of the present invention, an operation string can be expressed as an XML document. It will be clear to one of skill in the art that an operational string can contain any number of service elements and operational strings.

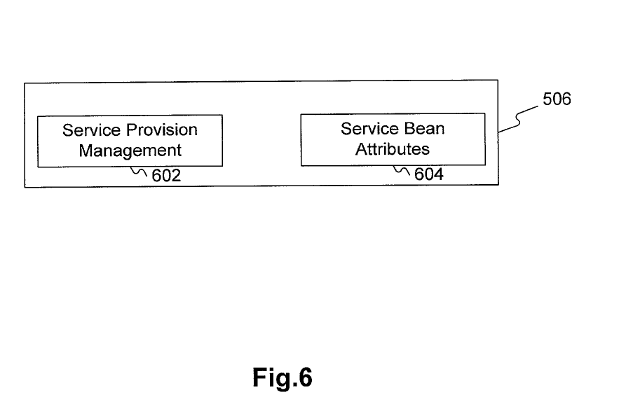

FIG. 6 is a block diagram of a service element in greater detail. A service element contains instructions for creating a corresponding service instance. In one implementation consistent with the present invention, service element 506 includes a service provision management object 602 and a service bean attributes object 604. Service provision management object 602 contains instructions for provisioning and monitoring the service that corresponds to service element 506. For example, if the service is a software application, these instructions may include the requirements of the software application, such as hardware requirements, response time, throughput, etc. Service bean attributes object 604 contains instructions for creating an instance of the service corresponding to service element 506. In one implementation consistent with the present invention, a service instance is referred to as a Jini™ Service Bean (JSB).

C. Jini™ Service Beans

A Jini™ Service Bean (JSB) is a Java™ object that provides a service in a distributed system. As such, a JSB implements one or more remote methods that together constitute the service provided by the JSB. A JSB is defined by an interface that declares each of the JSB's remote methods using Jini™ Remote Method Invocation (RMI) conventions. In addition to its remote methods, a JSB may include a proxy and a user interface consistent with the Jini™ architecture.

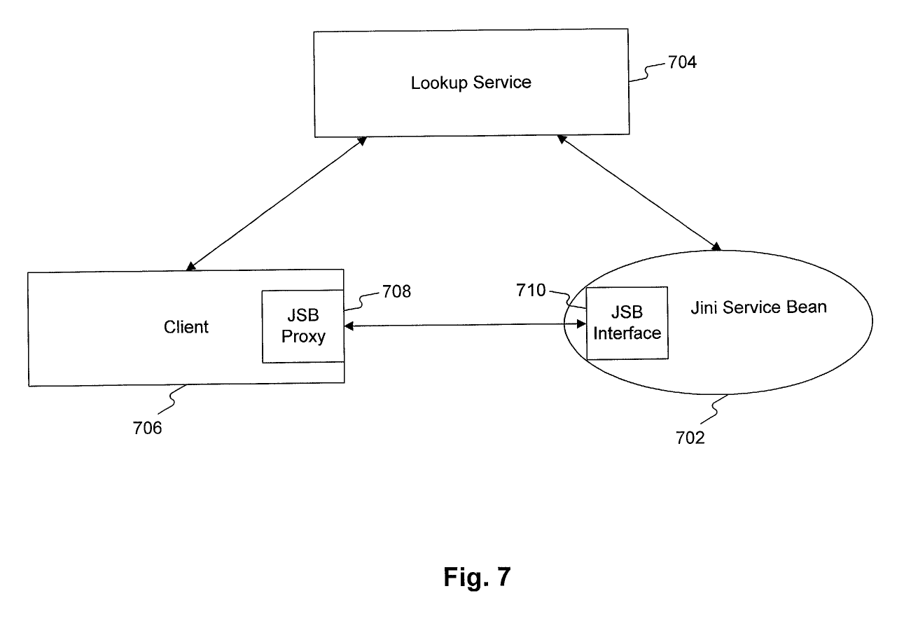

FIG. 7 depicts a block diagram of a system in which a JSB provides its service to a client. This system includes a JSB 702, a lookup service 704, and a client 706. When JSB 702 is created, it registers with lookup service 704 to make its service available to others in the distributed system. When a client 706 needs the service provided by JSB 702, client 706 sends a lookup request to lookup service 702 and receives in response a proxy 708 corresponding to JSB 706. Consistent with an implementation of the present invention, a proxy is a Java™ object, and its types (i.e., its interfaces and superclasses) represent its corresponding service. For example, a proxy object for a printer would implement a printer interface. Client 706 then uses JSB proxy 708 to communicate directly with JSB 702 via a JSB interface 710. This communication enables client 706 to obtain the service provided by JSB 702. Client 706 may be, for example, a process running on computer 102, and JSB 702 may be, for example, a process running on device 106.

D. Cybernode Processing

A JSB is created and receives fundamental life-cycle support from an infrastructure service called a “cybernode.” A cybernode runs on a compute resource, such as a computer or device. In one embodiment of the present invention, a cybernode runs as a Java™ virtual machine, such as JVM 220, on a computer, such as computer 102. Consistent with the present invention, a compute resource may run any number of cybernodes at a time and a cybernode may support any number of JSBs.

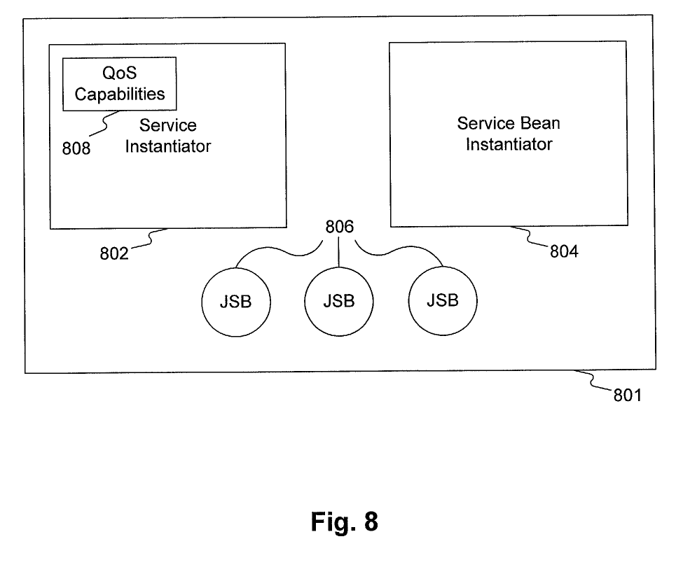

FIG. 8 depicts a block diagram of a cybernode. Cybernode 801 includes service instantiator 802 and service bean instantiator 804. Cybernode 801 may also include one or more JSBs 806 and one or more quality of service (QoS) capabilities 808. QoS capabilities 808 represent the capabilities, such as CPU speed, disk space, connectivity capability, bandwidth, etc., of the compute resource on which cybernode 801 runs.

Service instantiator object 802 is used by cybernode 801 to register its availability to support JSBs and to receive requests to instantiate JSBs. For example, using the Jini™ event handling process, service instantiator object 802 can register interest in receiving service provision events from a service provisioner, discussed below. A service provision event is typically a request to create a JSB. The registration process might include declaring QoS capabilities 808 to the service provisioner. These capabilities can be used by the service provisioner to determine what compute resource, and therefore what cybernode, should instantiate a particular JSB, as described in greater detail below. In some instances, when a compute resource is initiated, its capabilities are declared to the cybernode 801 running on the compute resource and stored as QoS capabilities 808.

Service bean instantiator object 804 is used by cybernode 801 to create JSBs 806 when service instantiator object 804 receives a service provision event. Using JSB attributes contained in the service provision event, cybernode 801 instantiates the JSB, and ensures that the JSB and its corresponding service remain available over the network. Service bean instantiator object 804 can be used by cybernode 801 to download JSB class files from a code server as needed.

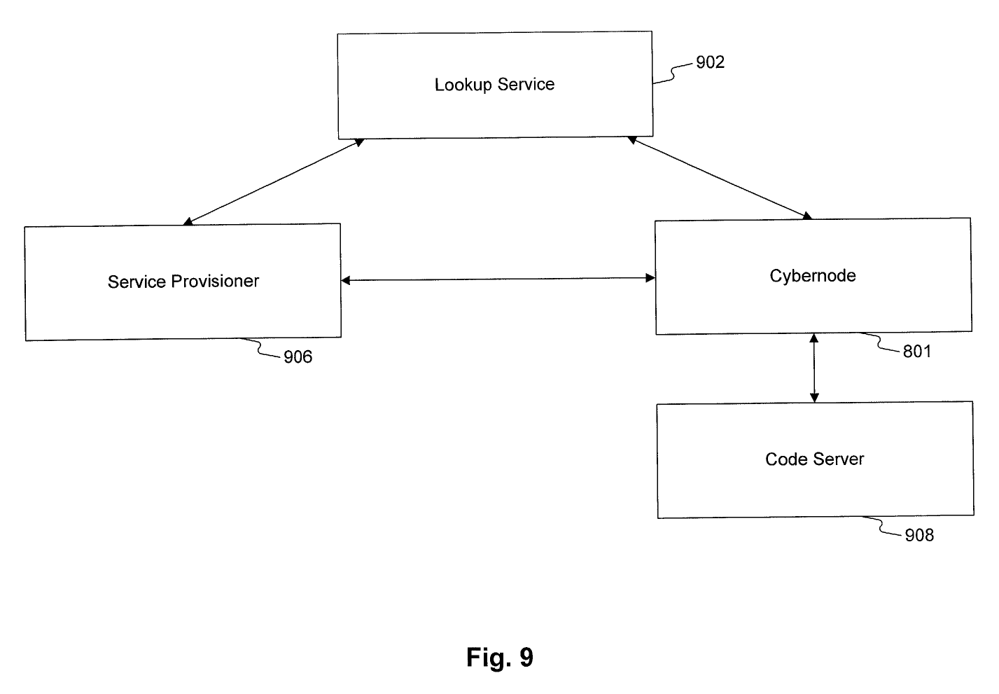

FIG. 9 depicts a block diagram of a system in which a cybernode interacts with a service provisioner. This system includes a lookup service 902, a cybernode 801, a service provisioner 906, and a code server 908. As described above, cybernode 801 is an infrastructure service that supports one or more JSBs. Cybernode 801 uses lookup service 902 to make its services (i.e., the instantiation and support of JSBs) available over the distributed system. When a member of the distributed system, such as service provisioner 906, needs to have a JSB created, it discovers cybernode 801 via lookup service 902. In its lookup request, service provisioner 906 may specify a certain capability that the cybernode should have. In response to its lookup request, service provisioner 906 receives a proxy from lookup service 902 that enables direct communication with cybernode 801.

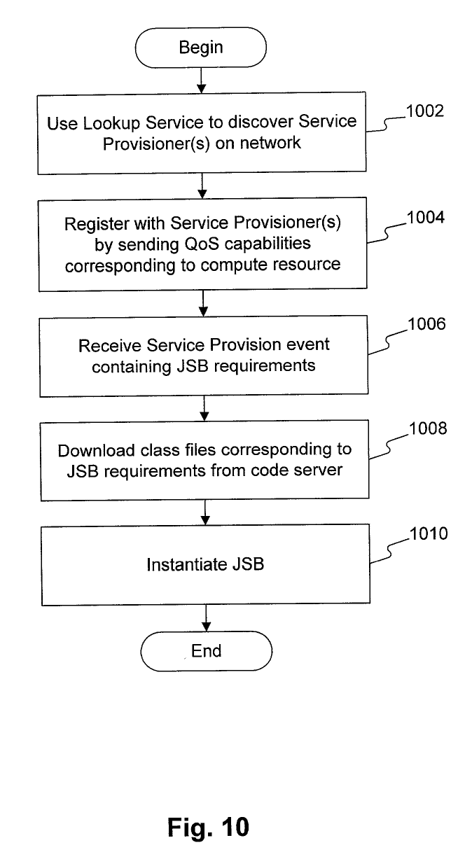

FIG. 10 is a flow chart of JSB creation performed by a cybernode. A cybernode, such as cybernode 801, uses lookup service 902 to discover one or more service provisioners 906 on the network (step 1002). Cybernode 801 then registers with service provisioners 906 by declaring the QoS capabilities corresponding to the underlying compute resource of cybernode 801 (step 1004). When cybernode 801 receives a service provision event containing JSB requirements from service provisioner 906 (step 1006), cybernode 801 may download class files corresponding to the JSB requirements from code server 908 (step 1008). Code server 908 may be, for example, an HTTP server. Cybernode 801 then instantiates the JSB (step 1010). As described above, JSBs and cybernodes comprise the basic tools to provide a service corresponding to a service element in an operational string consistent with the present invention. A service provisioner for managing the operational string itself will now be described.

E. Dynamic Service Provisioning

A service provisioner is an infrastructure service that provides the capability to deploy and monitor operational strings. As described above, an operational string is a collection of service elements that together constitute a complex service in a distributed system. To manage an operational string, a service provisioner determines whether a service instance corresponding to each service element in the operational string is running on the network. The service provisioner dynamically provisions an instance of any service element not represented on the network. The service provisioner also monitors the service instance corresponding to each service element in the operational string to ensure that the complex service represented by the operational string is provided correctly.

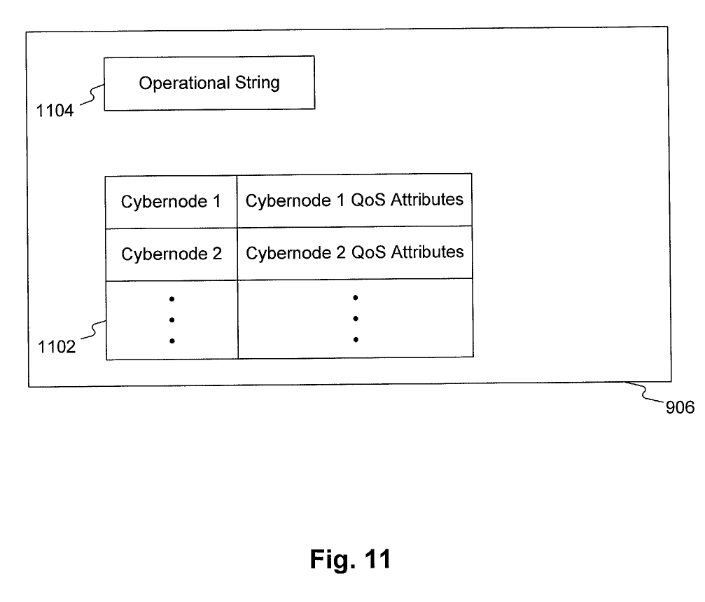

FIG. 11 is a block diagram of a service provisioner in greater detail. Service provisioner 906 includes a list 1102 of available cybernodes running in the distributed system. For each available cybernode, the QoS attributes of its underlying compute resource are stored in list 1102. For example, if an available cybernode runs on a computer, then the QoS attributes stored in list 1102 might include the computer's CPU speed or storage capacity. Service provisioner 406 also includes one or more operational strings 1104.

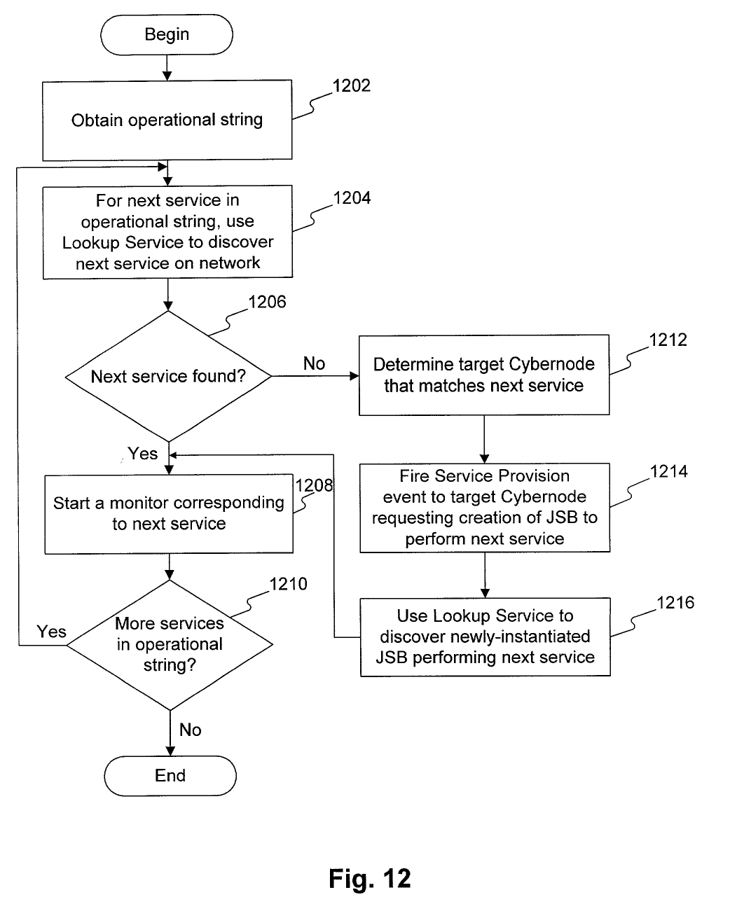

FIG. 12 is a flow chart of dynamic provisioning performed by a service provisioner. Service provisioner 906 obtains an operational string consisting of any number of service elements (step 1202). The operational string may be, for example, operational string 502 or 504. Service provisioner 906 may obtain the operational string from, for example, a programmer wishing to establish a new service in a distributed system. For the first service in the operational string, service provisioner 906 uses a lookup service, such as lookup service 902, to discover whether an instance of the first service is running on the network (step 1204). If an instance of the first service is running on the network (step 1206), then service provisioner 906 starts a monitor corresponding to that service element (step 1208). The monitor detects, for example, when a service instance fails. If there are more services in the operational string (step 1210), then the process is repeated for the next service in the operational string.

If an instance of the next service is not running on the network (step 1206), then service provisioner 906 determines a target cybernode that matches the next service (step 1212). The process of matching a service instance to a cybernode is discussed below. Service provisioner 906 fires a service provision event to the target cybernode requesting creation of a JSB to perform the next service (step 1214). In one embodiment, the service provision event includes service bean attributes object 604 from service element 506. Service provisioner 906 then uses a lookup service to discover the newly instantiated JSB (step 1216) and starts a monitor corresponding to that JSB (step 1208).

As described above, once a service instance is running, service provisioner 906 monitors it and directs its recovery if the service instance fails for any reason. For example, if a monitor detects that a service instance has failed, service provisioner 906 may issue a new service provision event to create a new JSB to provide the corresponding service. In one embodiment of the present invention, service provisioner 906 can monitor services that are provided by objects other than JSBs. The service provisioner therefore provides the ability to deal with damaged or failed resources while supporting a complex service.

Service provisioner 906 also ensures quality of service by distributing a service provision request to the compute resource best matched to the requirements of the service element. A service, such as a software component, has requirements, such as hardware requirements, response time, throughput, etc. In one embodiment of the present invention, a software component provides a specification of its requirements as part of its configuration. These requirements are embodied in service provision management object 602 of the corresponding service element. A compute resource may be, for example, a computer or a device, with capabilities such as CPU speed, disk space, connectivity capability, bandwidth, etc.

In one implementation consistent with the present invention, the matching of software component to compute resource follows the semantics of the Class.isAssignable( ) method, a known method in the Java™ programming language. If the class or interface represented by QoS class object of the software component is either the same as, or is a superclass or superinterface of, the class or interface represented by the class parameter of the QoS class object of the compute resource, then a cybernode resident on the compute resource is invoked to instantiate a JSB for the software component. Consistent with the present invention, additional analysis of the compute resource may be performed before the “match” is complete. For example, further analysis may be conducted to determine the compute resource's capability to process an increased load or adhere to service level agreements required by the software component.

F. Enhanced Event Handling

Systems consistent with the present invention may expand upon traditional Jini™ event handling by employing flexible dispatch mechanisms selected by an event producer. When more than one event consumer has registered interest in an event, the event producer can use any policy it chooses for determining the order in which it notifies the event consumers. The notification policy can be, for example, round robin notification, in which the event consumers are notified in the order in which they registered interest in an event, beginning with the first event consumer that registered interest. For the next event notification, the round robin notification will begin with the second event consumer in the list and proceed in the same manner. Alternatively, an event producer could select a random order for notification, or it could reverse the order of notification with each event.

As described above, in an implementation of the present invention, a service provisioner is an event producer and cybernodes register with it as event consumers. When the service provisioner needs to have a JSB instantiated to complete an operational string, the service provisioner fires a service provision event to all of the cybernodes that have registered, using an event notification scheme of its choosing.

G. Watchable Framework

Systems consistent with the present invention provide tools to collect metrics and make them available on a distributed system. Any type of metrics, such as quantities, elapsed time, and temperature, may be collected. The collected metrics are stored in distributed repositories running anywhere on the network. These repositories are available over the distributed system using the Jini™ lookup service described above.

In one implementation consistent with the present invention, a JSB can be “watchable” in the sense that it can create one or more watch objects to collect and store metrics. A watch object can measure any type of metric. For example, a stop watch object can measure a start time and an end time, and calculates the elapsed time. A periodic watch object can sleep for a set amount of time then wakes up and takes its measurement, for example a temperature. A memory watch object can check the status of a memory device at given intervals, for instance to track memory usage during peak computing hours. A threshold watch can include a minimum value and/or a maximum value, and an event producer to fire an event when a threshold is exceeded. Other watches might measure the time needed to execute a block of computer code, the number of hits on a radar track, or the number of phone calls traveling through a router in a given time period. One skilled in the art will recognize that any type of metric can be collected consistent with the present invention.

In one implementation consistent with the present invention, a watch object stores its metrics using a WatchDataSource interface that extends the Java™ RMI interface. The WatchDataSource interface stores one or more measured results and provides processes to add, clear, or fetch these results. As a repository of metrics, the WatchDataSource interface is unique in that it is written by the measuring agents themselves. A WatchDataSource interface registers as a service with one or more lookup services in a distributed system to make its stored metrics available to remote applications. For a given system, metrics might be collected in several WatchDataSource interfaces, all made available via one or more lookup services.

An implementation of at least a portion of a WatchDataSource interface using the Java™ programming language is described below:

### Interface WatchDataSource

public interface WatchDataSource

extends java.rmi.remote

methods:

getID (Get the ID for the WatchDataSource)

public java.lang.String getID ( )

throws java.rmi.RemoteException

getOffset (Get the offset)

public int getOffset ( )

throws java.rmi.RemoteException

setSize (Set the maximum size for the Calculable history)

public void setSize (int size)

throws java.rmi.RemoteException

Parameters: size—the maximum size for the Calculable history

getSize (Get the maximum size for the Calculable history)

public int getSize ( )

throws java.rmi.RemoteException

Returns: the maximum size for the Calculable history

clear (Clears history)

public void clear ( )

throws java.rmi.RemoteException

getCurrentSize (Get the current size for the Calculable history)

public int getcurrentSize( )

throws java.rmi.RemoteException

Returns: the current size for the Calculable history

addCalculable (Add a calculable record to the Calculable history)

public void addCalculable (Calculable Calculable)

throws java.rmi.RemoteException

Parameters: Calculable—the calculable record

Returns: the index where the calculable record was added

getCalculable (Get all Calculable records from the Calculable history)

public Calculable [ ] getCalculable ( )

throws java.rmi.RemoteException

Returns: all Calculable records from the Calculable history

getcalculable (Get Calculable records from the Calculable history)

public Calculable [ ] getcalculable (java.lang.String id)

throws Java.rmi.RemoteException

Parameters: id—the identifier to match

Returns: all Calculable records from the Calculable history that match the id

getCalculable (Get Calculable records from the Calculable history for the specified range)

public Calculable [ ] getCalculable (int offset, int length)

throws java.rmi.RemoteException

Parameters: offset—the index of the first record to fetch

length—the number of records to return

Returns: all Calculable records from the Calculable history that match the id

getCalculable (Get Calculable records from the Calculable history)

public Calculable [ ] getCalculable (java.lang.String id, int offset, int length)

throws java.rmi.RemoteException

Parameters: id—the identifier to match

offset—the index of the first record to match

length—the number of records to compare

Returns: all Calculable records from the Calculable history that match the id with the range

getLastCalculable (Get the last calculable from the history)

public Calculable getLastCalculable ( )

throws java.rmi.RemoteException

Returns: the last calculable

getLastCalculable (Get the last calculable from the history)

public Calculable getLastCalculable (java.lang.String id)

throws java.rmi.RemoteException

Returns: the last calculable

setHighThreshold (Set the high threshold value for this watch data source)

public void setHighThreshold (double value)

throws java.rmi.RemoteException

Parameters: value—the high threshold value for this watch data source

getHighThreshold (Get the high threshold value for this watch data source)

public double getHighThreshold ( )

throws java.rmi.RemoteException

Returns: the high threshold value for this watch data source

setLowThreshold (Set the low threshold value for this watch data source)

public void setLowThreshold (double value)

throws java.rmi.RemoteException

Parameters: value—the low threshold value for this watch data source

getLowThreshold (Get the low threshold value for this watch data source)

public double getLowThreshold ( )

throws java.rmi.RemoteException

Returns: the low threshold value for this watch data source

getThresholdStep (Getter for property thresholdStep)

public double getThresholdStep ( )

throws java.rmi.RemoteException

Returns: Value of property thresholdStep.

setThresholdStep (Setter for property thresholdStep)

public void setThresholdStep (double thresholdStep)

throws java.rmi.RemoteException

Parameters: thresholdStep—New value of property thresholdStep.

getThresholdValues (Getter for property thresholdValues)

public ThresholdValues getThresholdValues ( )

throws java.rmi.RemoteException

Returns: Value of property threshold Values.

setThresholdValues (Setter for property thresholdValues)

public void setThresholdValues (ThresholdValues thresholdValues)

throws java.rmi.RemoteException

Parameters: thresholdValues—New value of property threshold Values.

getThresholdExceededCount (Gets the count of exceeded thresholds)

public long getThresholdExceededCount ( )

throws java.rmi.RemoteException

getThresholdResetCount (Gets the count of reset thresholds)

public long getThresholdResetCount ( )

throws java.rmi.RemoteException

close (Close the watch data source)

public void close ( )

throws java.rmi.RemoteException

getViews (Getter for property views)

public java.lang.String [ ] getViews ( )

throws java.rmi.RemoteException

Returns: array of view class names

setViews (Setter for property views)

public void setViews (java.lang.String [ ] views)

throws java.rmi.RemoteException

Parameters: views—array of view class names

addView (Adds for property views)

public void addView (java.lang.String viewClass)

throws java.rmi.RemoteException

Parameters: the -view class name

getViews (Indexed getter for property views)

public java.lang.String getViews (int index)

throws java.rmi.RemoteException

Parameters: index—Index of the property.

Returns: Value of the property at index.

setViews

public void setViews (int index, java.lang.String views)

throws java.rmi.RemoteException

Indexed setter for property views.

Parameters: index—Index of the property.

views—New value of the property at index.

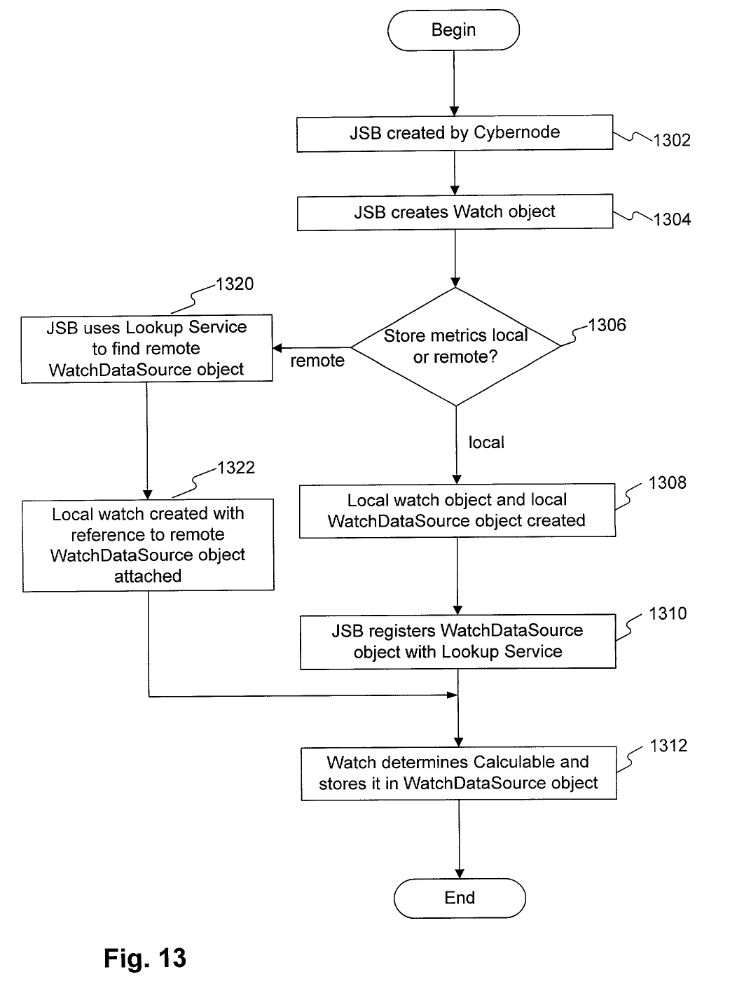

FIG. 13 is a flow chart of a process for collecting metrics consistent with the present invention. When a JSB is created by a cybernode (step 1302), the JSB creates a watch object (step 1304). The instructions to create a watch object can be received in a number of ways. For example, a user wishing to track a certain metric could include instructions for creating a watch object in the JSB's requirements. Alternatively, a process running in the distributed system could include code for creating and monitoring a watch object by instantiating a watchable JSB. However received, the instructions specify whether the watch object will store its results locally or remotely. In one implementation consistent with the present invention, the instructions take the form of an object constructor.

If the watch results will be stored locally, the JSB uses the object constructor to create both a watch object and a local WatchDataSource object (step 1308). The JSB registers its WatchDataSource object with a lookup service (step 1310). The watch then proceeds to collect its metrics and store them in the local WatchDataSource object (step 1312).

If the watch results will be stored remotely, the JSB uses a lookup service to find a remote WatchDataSource object (step 1320). To find the remote WatchDataSource object, a JSB implements a “watchable” interface that queries the lookup service and returns all available WatchDataSource objects. An implementation of the Watchable interface using the Java ™ programming language is described below:

### Interface Watchable

public interface Watchable

extends java.rmi.Remote

Methods:

fetch (Returns an array of all WatchDataSource objects which provide a reference to an implementation of WatchDataSource)

public WatchDataSource[ ] fetch( )

throws java.rmi.RemoteException

fetch (Returns an array of WatchDataSource objects which match the input id which corresponds to a Watch identifier. The WatchDataSource object(s) returned provides a reference to an implementation of WatchDataSource)

public WatchDataSource[ ] fetch(java.lang.String id)

throws java.rmi.RemoteException

setHighThreshold (Set the high threshold value for a ThresholdWatch identified by id)

public void setHighThreshold (java.lang.String id, double value)

throws java.rmi.RemoteException

Parameters: id—the watch id

value—the new threshold value

setLowThreshold (Set the low threshold value for a ThresholdWatch identified by id)

public void setLowThreshold (java.lang.String id, double value)

throws java.rmi.RemoteException

Parameters: id—the watch id

value—the new threshold value

setThresholdStep (Setter for property thresholdStep)

public void setThresholdStep (java.lang.String id, double thresholdStep)

throws java.rmi.RemoteException

Parameters: thresholdStep—New value of property thresholdStep.

getThresholdValues (Getter for property threshold Values)

public ThresholdValues getThresholdValues (java.lang.String id)

throws java.rmi.RemoteException

Returns: Value of property thresholdValues.

setThresholdValues (Setter for property thresholdValues)

public void setThresholdValues (java.lang.String id, ThresholdValues thresholdValues)

throws java.rmi.RemoteException

Parameters: thresholdValues—New value of property thresholdValues.

Alternatively, the JSB may look for a specific WatchDataSource object by name. The JSB passes a reference to the remote WatchDataSource object into the constructor that creates the watch object (step 1322). In this way, the watch is created with a remote reference to the WatchDataSource object attached. The watch then proceeds to collect its metrics and store them in the attached WatchDataSource object (step 1312). Consistent with the present invention, the watch object itself takes the measurements and the results of the measurements are called “calculables.” An implementation of a Calculable interface using the Java™ programming language is described below:

### Interface Calculable

public interface Calculable

extends java.io.Serializable

Methods:

getId (Getter for property id)

public java.lang.String getId( )

Returns: Value of property id.

setId (Setter for property id)

public void setId (java.lang.String id)

Parameters: id—New value of property id.

getValue (Getter for property value)

public double getValue( )

Returns: Value of property value.

SetValue (Setter for property value)

public void setValue (double value)

Parameters: value—New value of property value.

getArchiveRecord (gets an archival representation for this Calculable)

public java.lang.String getArchiveRecord( )

Returns: a string representation in archive format

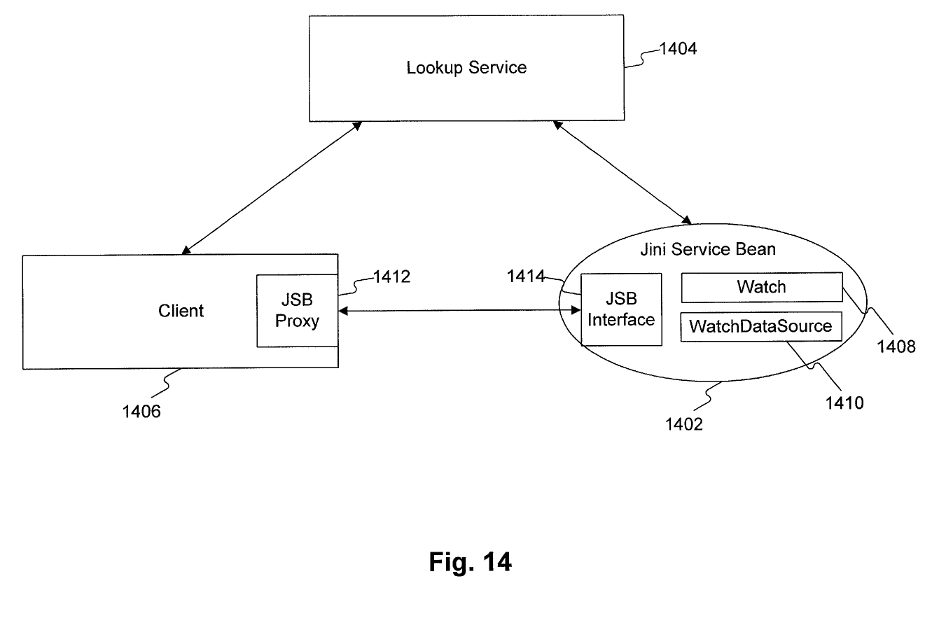

FIG. 14 is a block diagram of a system for collecting metrics and storing them locally. The system includes a Jini Service Bean (JSB) 1402, a lookup service 1404, and a client 1406. JSB 1402 includes a watch object 1408 and a WatchDataSource object 1410, created locally as described above. When watch object 1408 determines a measurement, it stores the measurement as a calculable in WatchDataSource object 1410. Once JSB 1402 creates WatchDataSource object 1410, it registers the object with lookup service 1404. Client 1406 may then discover WatchDataSource object 1410 by sending a lookup request to lookup service 1404 and receiving a proxy 1412 to JSB 1408. Client 1406 uses JSB proxy 1412 to communicate directly with JSB 1402 via a JSB interface 1414.

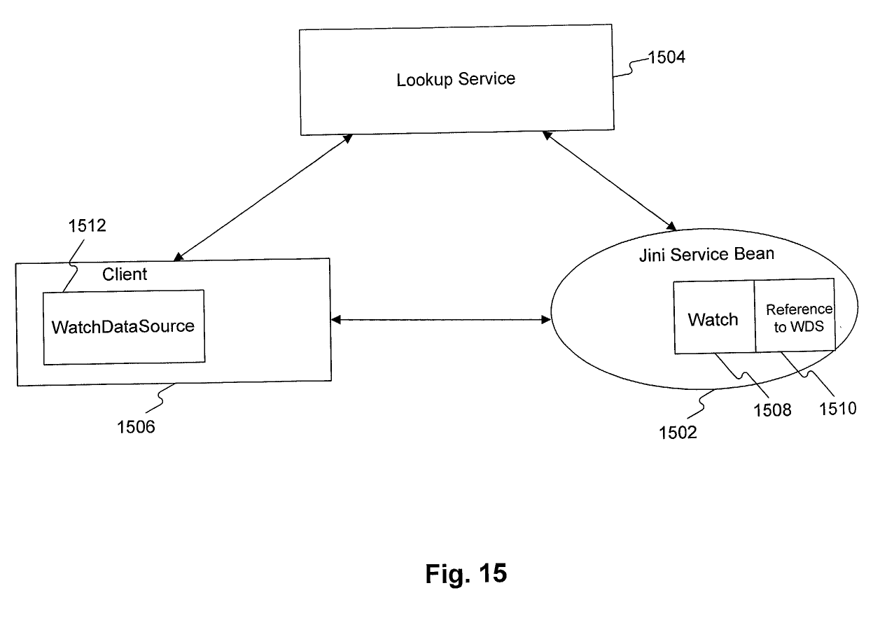

FIG. 15 is a block diagram of a system for collecting metrics and storing them remotely. The system includes a Jini Service Bean (JSB) 1502, a lookup service 1504, and a client 1506. JSB 1402 includes a watch object 1408. As described above, when JSB 1402 creates watch object 1408, it includes a reference 1510 to a remote WatchDataSource object 1512 running on client 1506. One skilled in the art will recognize that client 1506 may be a JSB or another type of object running on a remote computer or device anywhere in the distributed system. When watch object 1508 determines a measurement, it stores the measurement as a calculable in WatchDataSource object 1512. To do so, watch 1508 uses reference 1510 to communicate with client 1506.

Once JSB 1402 creates WatchDataSource object 1410, it registers the object with lookup service 1404. Client 1406 may then discover WatchDataSource object 1410 by sending a lookup request to lookup service 1404 and receiving a proxy 1412 to JSB 1408. Client 1406 uses JSB proxy 1412 to communicate directly with JSB 1402 via a JSB interface 1414.

In one embodiment of the present invention, an “archivable” interface may be used to save the contents of a WatchDataSource to a persistent data store. An implementation of the Archivable interface using the Java™ programming language is described below:

### Interface Archivable

public interface Archivable

Methods:

close (Closes the archive)

public void close( )

archive (Archive a record from the WatchDataSource history)

public void archive (Calculable calculable)

Parameters: calculable—the Calculable record to archive.

Using the Watchable framework described above, systems consistent with the present invention can collect metrics and make them available on a distributed system. Although the interfaces are described using the Java™ programming language, one skilled in the art will recognize that the watchable framework may be implemented using other programming languages and environments.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. Additional modifications and variations of the invention may be, for example, the described implementation includes software but the present invention may be implemented as a combination of hardware and software or in hardware alone. The invention may be implemented with both object-oriented and non-object-oriented programming systems.

Furthermore, one skilled in the art would recognize the ability to implement the present invention in many different situations. For example, the present invention can be applied to the telecommunications industry. A complex service, such as a telecommunications customer support system, may be represented as a collection of service elements such as customer service phone lines, routers to route calls to the appropriate customer service entity, and billing for customer services provided. The present invention could also be applied to the defense industry. A complex system, such as a battleship's communications system when planning an attack, may be represented as a collection of service elements including external communications, weapons control, and vessel control.

Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

What is claimed is:

1. A method for collecting metrics in a distributed system, comprising:
measuring a metric about a process running on a node in the distributed system; and
storing the metric in a data source available to other nodes in the distributed system, wherein the data source runs on the same node as the process.

2. The method of claim 1, further comprising:
sending an identifier of the data source to a lookup service in the distributed system to make the stored metric available to other nodes in the distributed system.

3. A method for collecting metrics in a distributed system, comprising:
measuring a metric about a process running on a node in the distributed system;
locating a data source running on a different node from the process; and
storing the metric in the data source, wherein the data source is available to other nodes in the distributed system.

4. The method of claim 3, the locating further comprising:
sending a request for the data source to a lookup service; and
receiving a proxy to the data source from the lookup service, wherein the proxy enables the storing of metrics in the data source.

5. A system for tracking metrics in a distributed system, comprising:
a data source configured to store metrics, the data source running on a node in the distributed system;
a measuring agent configured to
measure a metric related to a process in the distributed system, and
write the metric to the data source; and
a lookup service configured to
receive a registration for the data source, and
use the registration to make the data source available to other nodes in the distributed system.

6. The system of claim 5, wherein the measuring agent runs on the same node as the data source.

7. The system of claim 5, wherein the measuring agent runs on a different node from the data source.

8. The system of claim 5, wherein the registration includes a name of the data source and a proxy for the data source, the lookup service further configured to:
receive a request containing the name of the data source from a client process; and
in response to the request, send the proxy to the client process.

9. A method for collecting metrics in a distributed system, comprising:
creating a measuring agent to measure a metric related to a process in the distributed system, wherein the process and the measuring agent run on the same node in the distributed system;
creating a data source to store the metric measured by the measuring agent; and
registering the data source with a lookup service to make the stored metric available to other nodes in the distributed system.

10. The method of claim 9, wherein the data source runs on the same node as the process and the measuring agent.

11. The method of claim 9, wherein the data source runs on a different node from the process and the measuring agent.

12. A system for collecting metrics in a distributed system, comprising:
a plurality of data sources configured to store metrics, the data sources running on a plurality of nodes in the distributed system;
a measuring agent configured to
measure a metric related to a process in the distributed system, and
write the metric to one of the plurality of data sources as specified by the measuring agent; and
a lookup service configured to
store a list containing a reference to each of the plurality of data sources, and
responsive to a request from a client process, send to the client process the list containing the reference to each of the plurality of data sources.

13. The system of claim 12, wherein the reference to each data source includes an identifier of the data source and a proxy for the data source, the lookup service further configured to
receive from the client process the identifier of one of the plurality of data sources; and
send process the proxy for the data source to the client process.

14. A system for collecting metrics in a distributed system, comprising:
a measuring component configured to measure a metric about a process running on a node in the distributed system; and
a storing component configured to store the metric in a data source available to other nodes in the distributed system, wherein the data source runs on the same node as the process.

15. The system of claim 14, further comprising:
a sending component configured to send an identifier of the data source to a lookup service in the distributed system to make the stored metric available to other nodes in the distributed system.

16. A system for collecting metrics in a distributed system, comprising:
a measuring component configured to measure a metric about a process running on a node in the distributed system;
a locating component configured to locate a data source running on a different node from the process; and
a storing component configured to store the metric in the data source, wherein the data source is available to other nodes in the distributed system.

17. The system of claim 16, the locating further comprising:
a sending component configured to send a request for the data source to a lookup service; and
a receiving component configured to receive a proxy to the data source from the lookup service, wherein the proxy enables the storing of metrics in the data source.

18. A system for collecting metrics in a distributed system, comprising:
an agent creating component configured to create a measuring agent to measure a metric related to a process in the distributed system, wherein the process and the measuring agent run on the same node in the distributed system;
a source creating component configured to create a data source to store the metric measured by the measuring agent; and
a registering component configured to register the data source with a lookup service to make the stored metric available to other nodes in the distributed system.

19. The system of claim 18, wherein the data source runs on the same node as the process and the measuring agent.

20. The system of claim 18, wherein the data source runs on a different node from the process and the measuring agent.

21. A method for collecting metrics in a distributed system, comprising:
measuring a metric about a process running on a node in the distributed system;
sending a request for a data source to a lookup service;
receiving a proxy to the data source from the lookup service, wherein the proxy enables the storing of metrics in the data source; and
storing the metric in the data source, wherein the data source is available to other nodes in the distributed system.

22. The method of claim 21, wherein the data source runs on a different node from the process.
